(19) United States
(12) Patent Application Publication
(10) Pub. No.: US 2020/0404154 A1
(43) Pub. Date: Dec. 24, 2020

(54) IMAGE PROCESSING METHOD, DEVICE, AND SYSTEM, AND STORAGE MEDIUM

(71) Applicant: SZ DJI TECHNOLOGY CO., LTD., Shenzhen (CN)

(72) Inventors: Xianlong CEN, Shenzhen (CN); Gaoping BAI, Shenzhen (CN)

(21) Appl. No.: 17/009,024

(22) Filed: Sep. 1, 2020

Related U.S. Application Data
(63) Continuation of application No. PCT/CN2018/079328, filed on Mar. 16, 2018.

(51) Int. Cl. H04N 5/235; H04N 5/232; H04N 19/51

(52) U.S. Cl. CPC H04N 5/2355; H04N 19/51; H04N 5/23293; H04N 5/23206

(57) ABSTRACT

An image processing method includes, in response to detecting that a communication connection for image transmission is established between a photographing device and a terminal device, obtaining image processing information of the terminal device, obtaining link information of the communication connection, determining an image processing strategy based on the image processing information and the link information, controlling the photographing device to shoot an image according to the image processing strategy, and controlling an image transmission circuit of the photographing device to transmit the image to the terminal device according to the image processing strategy.

### CROSS-REFERENCE TO RELATED APPLICATION

This application is a continuation of International Application No. PCT/CN2018/079328 filed Mar. 16, 2018, the entire content of which is incorporated herein by reference.

### TECHNICAL FIELD

The present disclosure relates to the field of control technology, and in particular to an image processing method, device, and system, and a storage medium.

### BACKGROUND

With the development of computer technology, the application of image processing systems has become more and more extensive. An image processing system includes an image processing device and a terminal device. The image processing device includes an unmanned aerial vehicle (UAV), an unmanned vehicle, a robot, or another device provided with a photographing device. The terminal device includes a smart terminal such as a mobile phone or a tablet computer for displaying images. Take a UAV provided with an image processing device as an example, the image processing device may transmit an image shot by a photographing device mounted at the UAV to a terminal device for display.

However, in the process of image transmission, the display information such as the resolution of the terminal device is different from the display information of the image shot by the photographing device of the image processing device, and the link information such as the link bandwidth of the communication link may be different. This may cause problems such as poor image quality, blurred images, and waste of bandwidth when the image processing device transmits images to the terminal device. Therefore, how to transmit images more effectively has become a hot issue in research.

### SUMMARY

In accordance with the disclosure, there is provided an image processing method including, in response to detecting that a communication connection for image transmission is established between a photographing device and a terminal device, obtaining image processing information of the terminal device, obtaining link information of the communication connection, determining an image processing strategy based on the image processing information and the link information, controlling the photographing device to shoot an image according to the image processing strategy, and controlling an image transmission circuit of the photographing device to transmit the image to the terminal device according to the image processing strategy.

Also in accordance with the disclosure, there is provided an image processing device including a memory storing program instructions and a processor configured to execute the program instructions to, in response to detecting that a communication connection for image transmission is established between a photographing device and a terminal device, obtain image processing information of the terminal device, obtain link information of the communication connection, determine an image processing strategy based on the image processing information and the link information, control the photographing device to shoot an image according to the image processing strategy, and control an image transmission circuit of the photographing device to transmit the image to the terminal device according to the image processing strategy.

Also in accordance with the disclosure, there is provided an image processing system including an image processing device and a terminal device, The image processing device is configured to, in response to detecting that a communication connection for image transmission is established between a photographing device and the terminal device, obtain image processing information of the terminal device, obtain link information of the communication connection, determine an image processing strategy based on the image processing information and the link information, control the photographing device to shoot an image according to the image processing strategy, and control an image transmission circuit of the photographing device to transmit the image to the terminal device according to the image processing strategy. The terminal device is configured to receive the image transmitted by the image processing device and display the received image on a display screen of the terminal device.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a schematic structural diagram of an image processing system according to an embodiment of the disclosure.

FIG. 2 is a schematic flowchart of an image processing method according to an embodiment of the disclosure.

FIG. 3 is a schematic flowchart of another image processing method according to an embodiment of the disclosure.

FIG. 4 is a schematic flowchart of another image processing method according to an embodiment of the disclosure.

FIG. 5 is a schematic structural diagram of an image processing device according to an embodiment of the disclosure.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

The embodiments of the present disclosure are described as follows in detail with reference to the accompanying drawings. In the case of no conflict, the following embodiments and the features in the embodiments can be combined with each other.

The image processing method provided in the embodiment of the present disclosure may be executed by an image processing device, and the image processing device may be mounted at a device such as an aircraft (such as a UAV), an unmanned car, a robot, or a mobile terminal (such as a mobile phone) equipped with a photographing device. The photographing device includes an image transmission adapter, an image parameter adjustment circuit, an image transmission circuit, an encoding circuit, an image sensor, or the like. The image processing device may control the image sensor of the photographing device to shoot an image, and control the image transmission circuit of the photographing device to transmit the shot image to a terminal device for displaying the image. In one embodiment, the terminal device for displaying the image may include a terminal device such as a mobile phone, a tablet computer, and a smart watch. In some other embodiments, the image processing method may also be applied to other terminal devices equipped with photographing devices, which are not specifically limited in the embodiments of the present disclosure.

In the embodiments of the present disclosure, if a communication connection for transmitting an image established between the photographing device and the terminal device is detected by the image processing device, image processing information of the terminal device and the link information of the communication connection may be obtained. An image processing strategy may be determined by the image processing device based on the image processing information and the link information, the image sensor of the photographing device is controlled to shoot an image according to the instruction of the image processing strategy, and the image transmission circuit of the photographing device is controlled to transmit the shot image to the terminal device according to the instruction of the image processing strategy. In this way, the image processing information such as the resolution and bitstream of image transmission can be adjusted dynamically, and the image transmission circuit of the photographing device can be controlled to transmit images to the terminal device according to the adjusted image processing information by the image processing device obtaining the image processing information and link information of the terminal device in advance. Therefore, the user can have an experience with better image quality.

In some embodiments, the image processing device may obtain a start instruction of the photographing device and may detect whether a communication connection used to transmit the image is established between the photographing device and the terminal device when the start instruction of the photographing device is obtained. If a communication connection established between the photographing device and the terminal device is detected, the image processing device may obtain image processing information of the terminal device.

In some embodiments, the image processing information of the terminal device includes any one or more of display information, codec information, transmission protocol information, etc., and the display information includes the resolution and/or frame rate of the display screen of the terminal device, which is not specifically limited in this disclosure. In some embodiments, the terminal device refers to a terminal device that establishes a communication connection for image transmission with the image processing device and is configured to display the image transmitted by the image processing device. The terminal device includes an intelligent terminal device such as a mobile phone, a tablet computer and a smart watch, which is not specifically limited in the embodiments of the present disclosure.

In some embodiments, if the image processing device detects that the communication connection for transmitting images is established between the photographing device and the terminal device, the connection mode for establishing the communication connection can be obtained, and image processing information of the terminal device is obtained according to the connection mode.

In some embodiments, the connection mode of the communication connection includes a wired communication connection mode. When the image processing device detects that a communication connection for image transmission is established between the photographing device and the terminal device, if the connection mode of the communication connection is a wired communication connection mode, a communication protocol corresponding to the wired communication connection mode may be obtained, and image processing information of the terminal device may be obtained according to the communication protocol. In some embodiments, the wired communication connection mode includes a physical interface such as a high definition multimedia interface (HDMI) and other wired communication connection modes. For example, it is assumed that the connection mode of the communication connection is a wired communication connection mode, and the wired communication connection mode implements communication through a physical interface HDMI. If the image processing device detects that the connection mode of the communication connection is a communication connection established through a physical connection interface HDMI, the image processing device can obtain a communication protocol corresponding to the HDMI interface, and according to the communication protocol, obtain image processing information (such as display information like resolution, etc.) of the terminal device.

In some embodiments, the connection mode of the communication connection includes a wireless communication connection mode, and when the image processing device detects that a communication connection for transmitting an image is established between the photographing device and the terminal device, and if the connection mode of the communication connection is a wireless communication connection mode, the communication link corresponding to the wireless communication connection mode can be tested to obtain link information such as link bandwidth, and based on the link information, the image processing information of the terminal device is obtained. In some embodiments, the wireless communication connection mode includes but is not limited to wireless communication connection modes such as Wi-Fi and Bluetooth. For example, it is assumed that when the image processing device detects that a communication connection for transmitting an image is established between the photographing device and the terminal device, and if the connection mode of the communication connection is detected as a Wi-Fi connection and the link bandwidth of the communication link is obtained as 2M, the image processing device may obtain image processing information of the terminal device according to the 2M link bandwidth.

In some embodiments, if the image processing device detects that a communication connection for transmitting images is established between the photographing device and the terminal device, it may detect whether a dynamic adjustment function of image processing is enabled by the photographing device. If the detection result is on, an image processing information extraction request may be sent to the terminal device, so that the terminal device extracts the image processing information of the terminal device according to the extraction request, and the extracted image processing information is sent to the image processing device. Thereby, the image processing device obtains image processing information of the terminal device.

In some embodiments, the method of turning on the dynamic adjustment function of the image processing includes a turning on operation of an APP installed at the terminal device, a touch operation of a menu (such as a touchpad) for turning on the dynamic adjustment function of image processing built in the photographing device, or a click operation on a physical button for turning on the dynamic adjustment function of the image processing provided at the photographing device to turn on or off the dynamic adjustment function of the image processing.

In some embodiments, if the image processing device detects that the photographing device does not enable the dynamic adjustment function of image processing, the preset information may be determined as the image processing information of the terminal device. In some embodiments, the preset information includes any one or more of preset display information, preset codec information, preset transmission protocol information, or the like. For example, assume that the preset display information includes a preset resolution of 1024*768, if the image processing device detects that the photographing device does not enable the dynamic adjustment function of the image processing, the preset resolution of 1024*768 can be determined as the image processing information of the terminal device by the image processing device.

In some embodiments, if the image processing device detects that the photographing device does not enable the dynamic adjustment function of image processing, it may receive a user operation generated on a configuration interface and receive the image processing information obtained from the user operation on the configuration interface. In some embodiments, the user operation generated on the configuration interface is used for the user to manually configure image processing information (such as frame rate, resolution, codec information, etc.) on the configuration interface. In some embodiments, the image processing device may receive the user operation on the configuration interface and obtain the configured image processing information such as a frame rate, a resolution, and an encoding format corresponding to the user operation.

In some embodiments, after detecting that the photographing device is started, if the image processing device detects that the photographing device does not enable the dynamic adjustment function of image processing, it may receive the user operation generated on the configuration interface, and obtain image processing information of a default configuration selected by the user operation. The image processing information configured by default may be any image processing information (such as resolution, codec information, etc.) set by the user, which is not specifically limited in the embodiments of the present disclosure.

In some embodiments, the image processing information obtained by the image processing device includes display information and codec information. The image processing device may determine an image processing strategy based on the obtained display information and codec information of the terminal device. In some embodiments, the display information includes the resolution and/or frame rate of a display screen of the terminal device, and the determined image processing strategy indicates shooting parameters matched the display information and the codec information. In some embodiments, the image processing device may obtain link information of the communication connection, and the link information includes information such as a link bandwidth, a communication protocol, and a bandwidth required by the communication protocol, which is not limited in the embodiments of the present disclosure.

In some embodiments, the image processing device may configure the shooting parameters of the photographing device according to the instruction of the image processing strategy, and control the photographing device to shoot and obtain images according to the shooting parameters configured by the image processing strategy. With the shooting parameters, an image sensor of the photographing device shoots an image that matches the display information and the codec information.

In some embodiments, the image processing device may control the image transmission adapter of the image processing device to configure the shooting parameters of the photographing device, such as link information, the resolution and the frame rate, and etc. according to the instruction of the image processing strategy, and transmit the shooting parameters to the image sensor of the photographing device, so that the image sensor shoots an image that matches the display information and the codec information according to the shooting parameters. For example, assume that the image processing device configures the shooting parameters of the photographing device to a resolution of 1024*768 according to the display information of the terminal device indicated by the image processing strategy, the image processing device may transmit the shooting parameters to the image sensor of the photographing device, so that the image sensor shoots an image with the resolution of 1024*768 according to the shooting parameters.

In some embodiments, the image processing device may control the encoding circuit of the photographing device to encode the shot image with a target bitstream according to the instruction of the image processing strategy, and control the image transmission circuit of the photographing device to transmit the data obtained from the encoding process to the terminal device according to the instructions of the image processing strategy.

In some embodiments, the determined image processing strategy indicates encoding parameters associated with the codec information. The image processing device may configure the encoding parameters of the encoding circuit of the photographing device according to the instruction of the image processing strategy, and with the encoding parameters, the encoding circuit of the photographing device encodes the shot image with the target bitstream. The coding parameters include any one or more of the encapsulation format (such as GOP or GDR), the codec type (such as HEVC, H264, etc.), the bitrate type (CBR, VBR, CVBR, etc.), the ratio of I frame and P frame, etc. In some embodiments, the encoding parameter is determined according to any one or more of the link information of the communication connection obtained by the image processing device, the display information included in the image processing information, and the codec information. For example, the correspondence between the encoding parameter and the link information, the display information included in the image processing information, and the codec information may include, but is not limited to, the correspondence shown in Table 1.

TABLE 1

| Physical | Mobile Terminal, | Encapsulation | Codec | |
|---|---|---|---|---|
| Link | Resolution | Format | Type | bitrate |
| USB | iPad2, 1024*768 | GOP | H264 | CBR |
| USB | iPhone6, 1134*750 | GDR | H264 | CBR |
| USB/Wi-Fi | iPadPro, 2224*1668 | GDR | H265 | VBR |
| Wi-Fi | iPad2, 1024*768 | GDR | H265 | CBR |
| Wi-Fi | iPhone6, 1134*750 | GDR | H265 | VBR |

In some embodiments, the image processing information includes transmission protocol information of the terminal device, and the determined image processing strategy indicates a transmission protocol parameter associated with the transmission protocol information. When the image processing device controls the image transmission circuit of the photographing device to transmit the data obtained by the encoding process to the terminal device according to the instruction of the image processing strategy, it may configure the transmission protocol parameters of the image transmission circuit of the photographing device according to the instruction of the image processing strategy. With the transmission protocol parameters, the image transmission circuit of the photographing device encapsulates the data obtained by the encoding process and transmits the data obtained by the encoding process to the terminal device, so that the terminal device parses out parameters such as the encapsulation format (such as GOP or GDR), the codec type (such as HEVC or H264), the bitrate type (such as CBR, VBR, CVBR, etc.), the ratio of I frame and P frame, and etc. from the received data, and then parses and restores the image shot by the photographing device, and displays it on the display screen of the terminal device.

In some embodiments, if the image processing device detects that the display information in the obtained image processing information of the terminal device changes during image transmission, the image processing strategy may be re-determined based on the obtained new display information. According to the instruction of the re-determined image processing strategy, the photographing device is controlled to shoot images, and the images are transmitted to the terminal device according to the instruction of the image processing strategy.

An image processing method for a terminal device equipped with a photographing device will be described below with reference to the accompanying drawings.

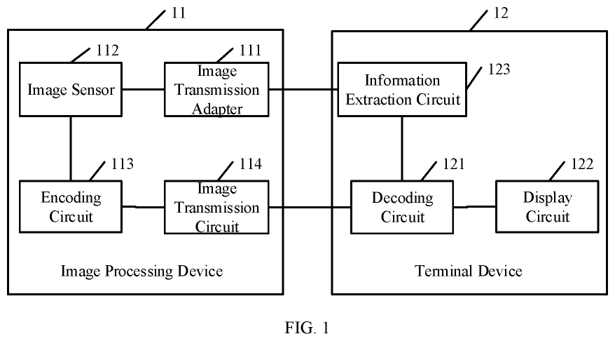

FIG. 1 is a schematic structural diagram of an image processing system according to an embodiment of the present disclosure. As shown in FIG. 1, the image processing system includes an image processing device 11 and a terminal device 12. The image processing device 11 includes an image transmission adapter 111, an image sensor 112, an encoding circuit 113, and an image transmission circuit 114. The terminal device 12 includes a decoding circuit 121, a display circuit 122, and an information extraction circuit 123.

In some embodiments, the image processing system may detect whether the image processing device 11 has established a communication connection for transmitting images with the terminal device 12 through the image processing device 11. If the detection result is yes, The image processing device 11 may send an extraction request for image processing information to the terminal device 12, and after receiving the extraction request, the terminal device 12 extracts the image processing information of the terminal device 12 through the information extraction circuit 123, and sends the image processing information to the image processing device 11, so that the image processing device 11 obtains the image processing information of the terminal device 12, and the image processing device 11 can also obtain the link information such as the communication protocol and link bandwidth of the communication connection. The image processing device 11 may determine an image processing strategy based on the image processing information and the link information. The image processing device 11 can control the image transmission adapter 111 of the image processing device 11 to configure the shooting parameters, such as any one or more of link information, the resolution rate, the frame rate, etc. of the photographing device configured in the image processing device 11 according to the instruction of the image processing strategy, and transmit the shooting parameters to the image sensor 112 of the photographing device, so that the image sensor 112 shoots an image that matches the display information and the codec information according to the shooting parameter. The image processing device 11 may encode the image shot by the image sensor 112 through the encoding circuit 113 and transmit the shot image to the terminal device 12 through the image transmission circuit 114. After receiving the image, the terminal device 12 performs decoding processing on the received image through the decoding circuit 121, and outputs and displays the decoded image through the display circuit 122.

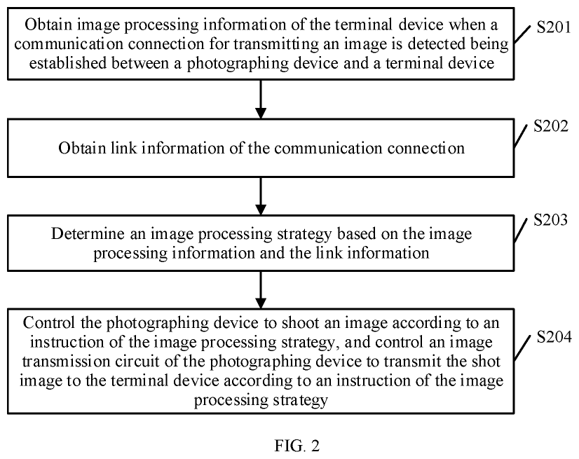

FIG. 2 is a schematic flowchart of an image processing method according to an embodiment of the present disclosure. The method may be executed by an image processing device, and a photographing device is provided on the image processing device. The specific explanation of the image processing device is described above. The method shown in FIG. 2 includes the following processes.

At S201, when a communication connection for transmitting an image is detected being established between a photographing device and a terminal device, image processing information of the terminal device is obtained.

In the embodiments of the present disclosure, the image processing device may obtain the image processing information of the terminal device when it detects that the communication connection for transmitting images is established between the photographing device and the terminal device. In some embodiments, the image processing information includes any one or more of display information, codec information, transmission protocol information, etc. of the terminal device, and the display information includes a resolution and/or a frame rate of a display screen of the terminal device, which is not limited in the embodiment of the present disclosure. In the embodiments, the image processing information of the terminal device is obtained so that the image processing device can determine an image processing strategy corresponding to the terminal device according to the image processing information. Therefore, the definition of the image displayed on the terminal device is improved.

In some embodiments, if the image processing device obtains the start instruction of the photographing device provided at the image processing device, the image processing device may detect whether the communication connection for transferring images is established between the photographing device and the terminal device.

At S202, link information of the communication connection is obtained.

In the embodiments of the present disclosure, if the image processing device detects that the communication connection for transmitting images is established between the photographing device and the terminal device, it may obtain link information of the communication connection. In some embodiments, the link information of the communication connection includes any one or more types of information such as a link bandwidth, a communication protocol, and a bandwidth required by the communication protocol, which is not limited in the embodiments of the disclosure.

At S203, an image processing strategy is determined based on the image processing information and the link information.

In the embodiments of the disclosure, the image processing device may determine the image processing strategy based on the image processing information and the link information. In some embodiments, when the image processing device detects that the communication connection for transmitting images is established between the photographing device and the terminal device, it may obtain the image processing information of the terminal device for displaying the image and the link information of the communication connection, and determine the image processing strategy based on the image processing information and the link information.

In some embodiments, the image processing information of the terminal device that establishes a communication connection with the image processing device is obtained by the image processing device and includes display information and codec information. The image processing device may determine the image processing strategy based on the obtained display information and codec information of the terminal device. In some embodiments, the display information includes the resolution and/or frame rate of the display screen of the terminal device, and the determined image processing strategy indicates shooting parameters matched the display information and the codec information.

For example, assume that the display information included in the image processing information obtained by the image processing device includes a resolution of 1024*768 and a frame rate of 18 fps of the display screen of the terminal device, the image processing device may determine an image processing strategy according to the obtained resolution of 1024*768 and frame rate of 18 fps of the terminal device, and the codec information. The determined image processing strategy indicates the shooting parameters that match the display information including the resolution of 1024*768 and the frame rate of 18 fps, and the codec information.

At S204, the photographing device is controlled to shoot an image according to instructions of the image processing strategy, and an image transmission circuit of the photographing device is controlled to transmit the shot image to the terminal device according to instructions of the image processing strategy.

In some embodiments, the image processing device may control an image sensor of the photographing device to shoot images according to the instruction of the image processing strategy, and control the image transmission circuit of the photographing device to transmit the shot images to the terminal device according to the instruction of the image processing strategy.

In some embodiments, the image processing device may configure the shooting parameters of the photographing device according to the instruction of the image processing strategy and control the image sensor of the photographing device to shoot images according to the shooting parameters configured according to the image processing strategy. With the shooting parameters, the image sensor of the photographing device shoots an image that matches the display information and the codec information.

In some embodiments, the image processing device may control the image transmission adapter of the image processing device to configure the shooting parameters of the photographing device, such as link information, a resolution, a frame rate, and etc., according to the instruction of the image processing strategy, and transmit the shooting parameters to the image sensor of the photographing device, so that the image sensor shoots an image that matches the display information and the codec information according to the shooting parameters. For example, assume that the image processing device configures the shooting parameters of the photographing device to a resolution of 1024*768 according to the display information of the terminal device indicated by the image processing strategy, the image processing device may transmit the shooting parameters to the image sensor of the photographing device, so that the image sensor shoots an image with the resolution of 1024*768 according to the shooting parameters.

In some embodiments, the image processing device may control the encoding circuit of the photographing device to encode the shot image with a target bitstream according to the instruction of the image processing strategy, and control the image transmission circuit of the photographing device to transmit the data obtained from the encoding process to the terminal device according to the instructions of the image processing strategy.

In some embodiments, the determined image processing strategy indicates encoding parameters associated with the codec information. The image processing device may configure the encoding parameters of the encoding circuit of the photographing device according to the instruction of the image processing strategy, and with the encoding parameters, the encoding circuit of the photographing device encodes the shot image with the target bitstream. The coding parameters include any one or more of the encapsulation format (such as GOP or GDR), the codec type (such as HEVC, H264, etc.), the bitrate type (CBR, VBR, CVBR, etc.), the ratio of I frame and P frame, etc.

In some embodiments, the encoding parameter is determined according to any one or more of the link information of the communication connection obtained by the image processing device, the display information included in the image processing information, and the codec information. In some embodiments, the correspondence between the encoding parameter and the link information, the display information included in the image processing information, and the codec information is shown in Table 1.

In some embodiments, the image processing information includes transmission protocol information of the terminal device, and the determined image processing strategy indicates a transmission protocol parameter associated with the transmission protocol information. When the image processing device controls the image transmission circuit of the photographing device to transmit the data obtained by the encoding process to the terminal device according to the instruction of the image processing strategy, it may configure the transmission protocol parameters of the image transmission circuit of the photographing device according to the instruction of the image processing strategy. With the transmission protocol parameters, the image transmission circuit of the photographing device encapsulates the data obtained by the encoding process and transmits the data obtained by the encoding process to the terminal device, so that the terminal device parses out parameters such as the encapsulation format (such as GOP or GDR), the codec type (such as HEVC or H264), the bitrate type (such as CBR, VBR, CVBR, etc.), the ratio of I frame and P frame, and etc. from the received data, and then parses and restores the image shot by the photographing device, and displays it on the display screen of the terminal device.

In some embodiments, if the image processing device detects that the display information in the obtained image processing information of the terminal device changes during image transmission, the image processing device may re-determine the image processing strategy based on the obtained new display information, and according to the instruction of the re-determined image processing strategy, control the image sensor of the photographing device to shoot images. The specific implementation process is the same as the above implementation process and is not repeated here.

In the embodiments of the present disclosure, when the image processing device detects that the communication connection for transmitting images is established between the photographing device and the terminal device, it obtains the image processing information of the terminal device, obtains link information of the communication connection, determines the image processing strategy based on the image processing information and the link information, controls the photographing device to shoot images according to the instruction of the image processing strategy, and controls the image transmission circuit of the photographing device to transmit the shot images to the terminal device according to the instruction of the image processing strategy. Therefore, the definition of the image is improved.

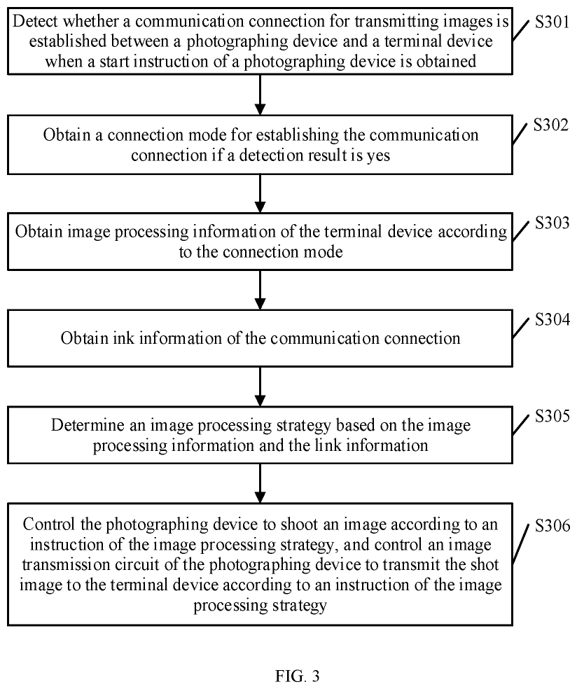

FIG. 3 is a schematic flowchart of another image processing method according to an embodiment of the present disclosure. The method may be executed by an image processing device, and the specific explanation of the image processing device is described above. The difference between the embodiment shown in FIG. 3 and the embodiment shown in FIG. 2 is that in the embodiment shown in FIG. 3, the image processing information of the terminal device is obtained according to an obtained connection mode of the communication connection for transmitting images established between the photographing device and the terminal device.

At S301, when a start instruction of a photographing device is obtained, it is detected whether a communication connection for transmitting images is established between a photographing device and a terminal device.

In the embodiments of the present disclosure, if the image processing device obtains the start instruction of the photographing device provided at the image processing device, it is detected whether a communication connection for transmitting images is established between the photographing device and the terminal device.

At S302, if a detection result is yes, a connection mode for establishing the communication connection is obtained.

In the embodiments of the present disclosure, if the image processing device detects that a communication connection for transmitting images is established between the photographing device provided at the image processing device and the terminal device, it may obtain the connection mode for establishing the communication connection. In some embodiments, the connection mode of the communication connection includes a wired communication connection mode and a wireless communication connection mode. The wired communication connection mode includes a physical interface such as a high definition multimedia interface (HDMI) and other wired communication connection modes, and the wireless communication connection mode includes Wi-Fi, Bluetooth and other wireless communication connection modes.

At S303, image processing information of the terminal device is obtained according to the connection mode.

In the embodiments of the present disclosure, the image processing device may obtain the image processing information of the terminal device according to the obtained connection mode of the communication connection established between the image processing device and the terminal device.

In some embodiments, if the image processing device detects that the connection mode of the communication connection is the wired communication connection mode, a communication protocol corresponding to the wired communication connection mode may be obtained, and image processing information of the terminal device may be obtained according to the communication protocol. The wired communication connection mode is described above and is not repeated here. For example, it is assumed that the connection mode of the communication connection is a wired communication connection mode, and the wired communication connection mode implements communication through a physical interface HDMI. When the image processing device obtains the image processing information of the terminal device, if it detects that the connection mode of the communication connection is a communication connection established through a physical connection interface HDMI, the image processing device can obtain a communication protocol corresponding to the HDMI interface, and according to the communication protocol, obtain image processing information of the terminal device.

In some embodiments, when the image processing device obtains the image processing information of the terminal device, if it detects the connection mode of the communication connection is a wireless communication connection mode, the communication link corresponding to the wireless communication connection mode can be tested to obtain a link bandwidth, and based on the link information, the image processing information of the terminal device is obtained. The specific embodiments and examples are as described above and is not repeated here.

At S304, link information of the communication connection is obtained.

In the embodiments of the present disclosure, if the image processing device detects that the communication connection for transmitting images is established between the photographing device and the terminal device, it may obtain the link information of the communication connection. In some embodiments, the link information of the communication connection includes information such as a link bandwidth, a communication protocol, and a bandwidth required by the communication protocol, which is not specifically limited in the embodiments of the disclosure.

At S305, an image processing strategy is determined based on the image processing information and the link information.

In the embodiments of the present disclosure, the image processing device may determine the image processing strategy based on the image processing information and the link information. In some embodiments, when the image processing device detects that the communication connection for transmitting images is established between the photographing device and the terminal device, it may obtain the image processing information of the terminal device for displaying the image and the link information of the communication connection, and based on the image processing information and the link information, determine the image processing strategy.

At S306, the photographing device is controlled to shoot an image according to an instruction of the image processing strategy, and an image transmission circuit of the photographing device is controlled to transmit the shot image to the terminal device according to an instruction of the image processing strategy.

In the embodiments of the present disclosure, the image processing device may control the photographing device to shoot images according to the instruction of the image processing strategy, and control the image transmission circuit of the photographing device to transmit the shot images to the terminal device according to the instruction of the image processing strategy.

In some embodiments, the image processing device may configure the shooting parameters of the photographing device according to the instruction of the image processing strategy, and control the photographing device to shoot and obtain images according to the shooting parameters configured by the image processing strategy. With the shooting parameters, an image sensor of the photographing device shoots an image that matches the display information and the codec information.

In some embodiments, the image processing device may control an image transmission adapter of the image processing device to configure the shooting parameters of the photographing device, such as link information, the resolution and the frame rate, and etc. according to the instruction of the image processing strategy, and transmit the shooting parameters to the image sensor of the photographing device, so that the image sensor shoots an image that matches the display information and the codec information according to the shooting parameters. For example, assume that the image processing device configures the shooting parameters of the photographing device to a resolution of 1024*768 according to the display information of the terminal device indicated by the image processing strategy, the image processing device may transmit the shooting parameters to the image sensor of the photographing device, so that the image sensor shoots an image with the resolution of 1024*768 according to the shooting parameters.

In some embodiments, the image processing device may control the encoding circuit of the photographing device to encode the shot image with a target bitstream according to the instruction of the image processing strategy, and control the image transmission circuit of the photographing device to transmit the data obtained from the encoding process to the terminal device according to the instructions of the image processing strategy.

In some embodiments, the determined image processing strategy indicates encoding parameters associated with the codec information. The image processing device may configure the encoding parameters of the encoding circuit of the photographing device according to the instruction of the image processing strategy, and with the encoding parameters, the encoding circuit of the photographing device encodes the shot image with a target bitstream. The explanation of the encoding parameters is described above and is not repeated here.

In some embodiments, the encoding parameter is determined according to any one or more of the link information of the communication connection obtained by the image processing device, the display information included in the image processing information, and the codec information. In some embodiments, the correspondence between the encoding parameter and the link information, the display information included in the image processing information, and the codec information may include is shown as Table 1.

In some embodiments, the image processing information includes transmission protocol information of the terminal device, and the determined image processing strategy indicates a transmission protocol parameter associated with the transmission protocol information. When the image processing device controls the image transmission circuit of the photographing device to transmit the data obtained by the encoding process to the terminal device according to the instruction of the image processing strategy, it may configure the transmission protocol parameters of the image transmission circuit of the photographing device according to the instruction of the image processing strategy. With the transmission protocol parameters, the image transmission circuit of the photographing device encapsulates the data obtained by the encoding process and transmits the data obtained by the encoding process to the terminal device, so that the mobile terminal device parses and restores the image shot by the photographing device from the received data, and displays it on the display screen of the terminal device.

In some embodiments, if the image processing device detects that the display information in the obtained image processing information of the terminal device changes during image transmission, the image processing device may re-determine the image processing strategy based on the obtained new display information, and according to the instruction of the re-determined image processing strategy, control the photographing device to shoot images. The specific implementation process is the same as the above implementation process and is not repeated here.

In the embodiments of the present disclosure, the image processing device obtains the image processing information of the terminal device and the link information of the communication connection according to the connection mode of the communication connection established between the photographing device and the terminal device for transmitting images, determines the image processing strategy based on the image processing information and the link information, controls the photographing device to shoot images according to the instruction of the image processing strategy, and controls the image transmission circuit of the photographing device to transmit the shot images to the terminal device according to the instruction of the image processing strategy. In this way, the definition of the image is improved, and the waste of communication link resources is avoided.

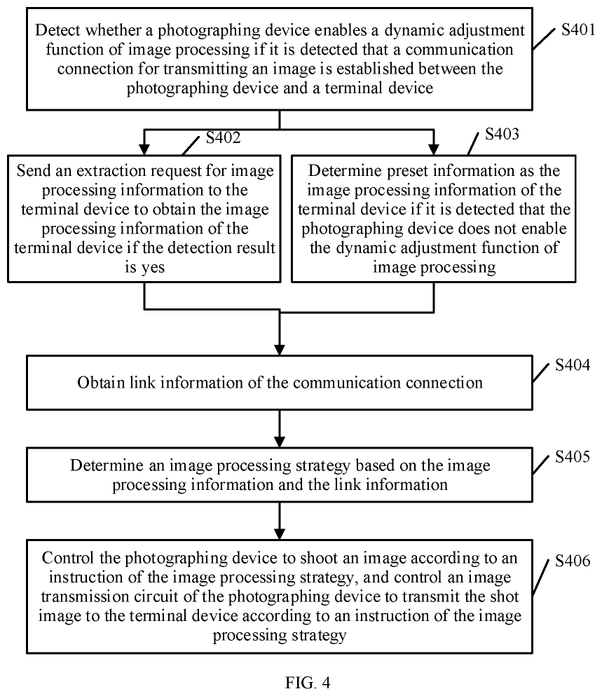

FIG. 4 is a schematic flowchart of another image processing method according to an embodiment of the present disclosure. The method may be executed by an image processing device, and the specific explanation of the image processing device is described above. The difference between the embodiment shown in FIG. 4 and the embodiment shown in FIG. 3 is that, in the embodiment shown in FIG. 4, if it is detected that the photographing device enables a dynamic adjustment function of image processing, an extraction request for image processing information is sent to the terminal device to obtain the image processing information of the terminal device.

At S401, if it is detected that a communication connection for transmitting an image is established between a photographing device and a terminal device, it is detected whether the photographing device enables a dynamic adjustment function of image processing.

In the embodiments of the disclosure, if the image processing device detects that the communication connection for transmitting images is established between the photographing device and the terminal device, it may detect whether the photographing device enables the dynamic adjustment function of image processing.

At S402, if the detection result is yes, an extraction request for image processing information is sent to the terminal device to obtain the image processing information of the terminal device, and the process of S404 is performed.

In the embodiments of the present disclosure, if the image processing device detects that the photographing device enables the dynamic adjustment function of image processing, the image processing device may send an extraction request for image processing information to the terminal device to obtain the image processing information of the terminal device. In some embodiments, the manner of enabling the dynamic adjustment function of the image processing is described above, and is not repeated here.

At S403, if it is detected that the photographing device does not enable the dynamic adjustment function of image processing, preset information is determined as the image processing information of the terminal device, and the process of S404 is performed.

In some embodiments, after detecting that the photographing device is started, if the image processing device detects that the photographing device does not enable the dynamic adjustment function of image processing, the preset information may be determined as the image processing information of the terminal device. In some embodiments, the preset information includes any one or more of preset display information, preset codec information, preset transmission protocol information, or the like. For example, if the image processing device detects that the photographing device does not enable the dynamic adjustment function of image processing, the image processing device may select any one or more of preset display information, codec information, transmission protocol information, etc. and determine them as the image processing information of the terminal device.

In some embodiments, after detecting that the photographing device is started, if the image processing device detects that the photographing device does not enable the dynamic adjustment function of image processing, it may receive a user operation generated on a configuration interface and receive the image processing information obtained from the user operation on the configuration interface. In some embodiments, the user operation generated on the configuration interface is used for the user to manually configure image processing information on the configuration interface. In some embodiments, the image processing device may receive the user operation on the configuration interface and obtain the configured image processing information such as a bitstream size, a resolution, and an encoding format corresponding to the user operation.

In some embodiments, after detecting that the photographing device is started, if the image processing device detects that the photographing device does not enable the dynamic adjustment function of image processing, it may receive the user operation generated on the configuration interface, and obtain image processing information of a default configuration selected by the user operation.

At S404, link information of the communication connection is obtained.

In the embodiments of the present disclosure, if the image processing device detects that the communication connection for transmitting images is established between the photographing device and the terminal device, it may obtain the link information of the communication connection. In some embodiments, the link information of the communication connection includes information such as a link bandwidth, a communication protocol, and a bandwidth required by the communication protocol, which is not specifically limited in the embodiments of the disclosure.

At S405, an image processing strategy is determined based on the image processing information and the link information.

In the embodiments of the present disclosure, the image processing device may determine the image processing strategy based on the image processing information and the link information. In some embodiments, when the image processing device detects that the communication connection for transmitting images is established between the photographing device and the terminal device, it may obtain the image processing information of the terminal device for displaying the image and the link information of the communication connection, and based on the image processing information and the link information, determine the image processing strategy.

At S406, the photographing device is controlled to shoot an image according to an instruction of the image processing strategy, and an image transmission circuit of the photographing device is controlled to transmit the shot image to the terminal device according to an instruction of the image processing strategy.

In the embodiments of the present disclosure, the image processing device may control the photographing device to shoot images according to the instruction of the image processing strategy, and control the image transmission circuit of the photographing device to transmit the shot images to the terminal device according to the instruction of the image processing strategy. The specific embodiments are as described above and are be repeated here.

In the embodiments of the present disclosure, the image processing device determines the image processing strategy based on the obtained image processing information and link information, controls the photographing device to shoot images according to the instruction of the image processing strategy, and controls the image transmission circuit of the photographing device to transmit the shot image to the terminal device according to the instruction of the image processing strategy. In this way, the waste of communication link resources is avoided, and the definition of image transmitted is improved.

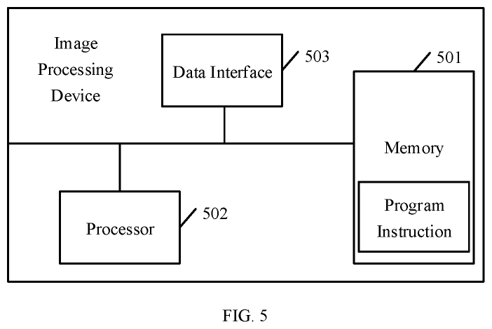

FIG. 5 is a schematic structural diagram of an image processing device according to an embodiment of the present disclosure. The image processing device includes a memory 501, a processor 502, and a data interface 503.

The memory 501 may include a volatile memory. The memory 501 may also include a non-volatile memory, and the memory 501 may also include a combination of the foregoing types of memories. The processor 502 may be a central processing unit (CPU). The processor 502 may further include a hardware chip. The above hardware chip may be an application-specific integrated circuit (ASIC), a programmable logic device (PLD), or a combination thereof. For example, it may be a complex programmable logic device (CPLD), a field-programmable gate array (FPGA), or any combination thereof.

Further, the memory 501 is used to store program instructions. When the program instructions are executed, the processor 502 may call the program instructions stored in the memory 501 to obtain image processing information of a terminal device when a communication connection for transmitting images is detected being established between a photographing device and a terminal device, obtain link information of the communication connection, determine an image processing strategy based on the image processing information and the link information, and control the photographing device to shoot images according to an instruction of the image processing strategy and controlling an image transmission circuit of the photographing device to transmit the shot image to the terminal device according to an instruction of the image processing strategy.

Further, the processor 502 calls program instructions stored in the memory 501 to determine the image processing strategy according to obtained display information, and codec information of the terminal device. The display information includes a resolution and/or a frame rate of a display screen of the terminal device, and the determined image processing strategy includes shooting parameters that match the display information and the codec information.

Further, the processor 502 calls program instructions stored in the memory 501 to configure the shooting parameters of the photographing device according to the instruction of the image processing strategy, and control the photographing device to shoot an image according to the shooting parameters configured by the image processing strategy. With the shooting parameters, an image sensor of the photographing device shoots an image that matches the display information.

Further, the processor 502 calls program instructions stored in the memory 501 to control the photographing device to encode the shot image with a target bitstream according to the instruction of the image processing strategy, and control the image transmission circuit of the photographing device to transmit the data obtained by an encoding process to the terminal device according to the instruction of the image processing strategy.

Further, the processor 502 calls program instructions stored in the memory 501 to configure encoding parameters of an encoding circuit of the photographing device according to the instruction of the image processing strategy. With the encoding parameters, the encoding circuit of the photographing device encodes the shot image with the target bitstream.

Further, the processor 502 calls program instructions stored in the memory 501 to configure transmission protocol parameters of the image transmission circuit of the photographing device according to the instruction of the image processing strategy. With the transmission protocol parameters, the image transmission circuit of the photographing device transmits the data obtained by the encoding process to the terminal device.

Further, the processor 502 calls program instructions stored in the memory 501 to detect whether the communication connection for transmitting images is established between the photographing device and the terminal device when a start instruction of the photographing device is obtained, and obtain the image processing information of the terminal device if a detection result is yes.

Further, the processor 502 calls program instructions stored in the memory 501 to obtain a connection mode for establishing the communication connection if it is detected that the communication connection for transmitting images is established between the photographing device and the terminal device, and obtain the image processing information of the terminal device according to the connection mode.

Further, the processor 502 calls program instructions stored in the memory 501 to obtain a communication protocol corresponding to a wired communication connection mode if it is detected that the connection mode of the communication connection is the wired communication connection mode, and obtain the image processing information of the terminal device according to the communication protocol.

Further, the processor 502 calls program instructions stored in the memory 501 to test a communication link corresponding to a wireless communication connection mode to obtain bandwidth information if it is detected that the connection mode of the communication connection is the wireless communication connection mode, and obtain the image processing information of the terminal device according to the bandwidth information.

Further, the processor 502 calls program instructions stored in the memory 501 to detect whether the photographing device enables a dynamic adjustment function of image processing if it is detected that the communication connection for transmitting images is established between the photographing device and the terminal device, and send an extraction request for image processing information to the terminal device to obtain the image processing information of the terminal device if the detection result is yes.

Further, the processor 502 calls program instructions stored in the memory 501 to determine preset information as the image processing information of the terminal device if it is detected that the photographing device does not enable the dynamic adjustment function of image processing.

Further, the processor 502 calls program instructions stored in the memory 501 to receive a user operation generated on a configuration interface if it is detected that the photographing device does not enable the dynamic adjustment function of image processing, and obtain image processing information configured by the user operation on the configuration interface.

Further, the processor 502 calls program instructions stored in the memory 501 to receive a user operation generated on the configuration interface if it is detected that the photographing device does not enable the dynamic adjustment function of image processing, and obtain image processing information of a default configuration selected by the user operation.

In the embodiments of the present disclosure, when the image processing device detects that the communication connection for transmitting images is established between the photographing device and the terminal device, it obtains the image processing information of the terminal device, obtains link information of the communication connection, determines the image processing strategy based on the image processing information and the link information, controls the photographing device to shoot images according to the instruction of the image processing strategy, and controls the image transmission circuit of the photographing device to transmit the shot images to the terminal device according to the instruction of the image processing strategy. In this way, the matching degree of the image transmission clarity and the image processing information of the terminal device for displaying the image is improved, and the definition of the image is improved.

An image processing system if further provided according to an embodiment of the disclosure, and the image processing system includes an image processing device and a terminal device.

The image processing device is configured to detect that a communication connection for transmitting images is established between a photographing device and the terminal device, obtain the image processing information of the terminal device, obtain link information of the communication connection, determine an image processing strategy based on the image processing information and the link information, control the photographing device to shoot images according to an instruction of the image processing strategy, and control an image transmission circuit of the photographing device to transmit the shot images to the terminal device according to an instruction of the image processing strategy.

The terminal device is configured to receive the image transmitted by the image processing device and display the received image on a display screen of the terminal device.

Further, the image processing device is configured to determine the image processing strategy based on the obtained display information and codec information of the terminal device. The display information includes a resolution and/or a frame rate of the display screen of the terminal device, and the determined image processing strategy includes shooting parameters that match the display information and the codec information.

Further, the image processing device is configured to configure shooting parameters of the photographing device according to the instruction of the image processing strategy and control the photographing device to shoot images according to the shooting parameters configured by the image processing strategy. With the shooting parameters, an image sensor of the photographing device shoots an image that matches the display information.

Further, the image processing device is configured to control the photographing device to encode the shot image with a target bitstream according to an instruction of the image processing strategy, and control the image transmission circuit of the photographing device to transmit the data obtained by the encoding process to the terminal device according to the instruction of the image processing strategy.

Further, the image processing device is configured to configure encoding parameters of an encoding circuit of the photographing device according to an instruction of the image processing strategy. With the encoding parameters, the encoding circuit of the photographing device encodes the shot image with the target bitstream.

Further, the image processing device is configured to configure transmission protocol parameters of the image transmission circuit of the photographing device according to the instruction of the image processing strategy. With the transmission protocol parameters, the image transmission circuit of the photographing device transmits the data obtained by the encoding process to the terminal device.

Further, the image processing device is configured to detect whether the communication connection for transmitting images is established between the photographing device and the terminal device when a start instruction of the photographing device is obtained, and obtain the image processing information of the terminal device if a detection result is yes.

Further, the image processing device is configured to obtain a connection mode for establishing the communication connection if it is detected that the communication connection for transmitting images is established between the photographing device and the terminal device, and obtain the image processing information of the terminal device according to the connection mode.

Further, the image processing device is configured to obtain a communication protocol corresponding to a wired communication connection mode if it is detected that the connection mode of the communication connection is the wired communication connection mode and obtain the image processing information of the terminal device according to the communication protocol.

Further, the image processing device is configured to test a communication link corresponding to a wireless communication connection mode to obtain bandwidth information if it is detected that the connection mode of the communication connection is the wireless communication connection mode and obtain the image processing information of the terminal device according to the bandwidth information.

Further, the image processing device is configured to detect whether the photographing device enables a dynamic adjustment function of image processing if it is detected that the communication connection for transmitting images is established between the photographing device and the terminal device and send an extraction request for image processing information to the terminal device to obtain the image processing information of the terminal device if the detection result is yes.

Further, the image processing device is configured to determine preset information as the image processing information of the terminal device if it is detected that the photographing device does not enable the dynamic adjustment function of image processing.

Further, the image processing device is configured to receive a user operation generated on a configuration interface if it is detected that the photographing device does not enable the dynamic adjustment function of image processing and obtain image processing information configured by the user operation on the configuration interface.

Further, the image processing device is configured to receive a user operation generated on the configuration interface if it is detected that the photographing device does not enable the dynamic adjustment function of image processing and obtain image processing information of a default configuration selected by the user operation.

In the embodiments of the present disclosure, when the image processing device detects that the communication connection for transmitting images is established between the photographing device and the terminal device, it obtains the image processing information of the terminal device, obtains link information of the communication connection, determines the image processing strategy based on the image processing information and the link information, controls the photographing device to shoot images according to the instruction of the image processing strategy, and controls the image transmission circuit of the photographing device to transmit the shot images to the terminal device according to the instruction of the image processing strategy. In this way, the matching degree of the image transmission clarity and the image processing information of the terminal device for displaying the image is improved, and the definition of the image is improved.

A computer readable storage medium is also provided according to an embodiment of the disclosure. The computer readable storage medium stores a computer program. The computer program is executed by a processor to implement the image processing methods described in the embodiments corresponding to FIG. 2, 3 or 4, and the image processing device described in the embodiment corresponding to FIG. 5. Details are not described herein again.

The computer readable storage medium may be an internal storage unit of the device described in any of the foregoing embodiments, such as a hard disk or a memory of the device. The computer readable storage medium may also be an external storage unit of the device, such as a plug-in hard disk equipped at the device, a smart media card (SMC), a secure digital (SD) card, a flash card, etc. Further, the computer readable storage medium may also include both the internal storage unit and the external storage unit. The computer readable storage medium is used to store the computer program and other programs and data required by the terminal. The computer readable storage medium may also be used to temporarily store data that has been or will be output.

A person of ordinary skill in the art may understand that all or part of the processes in the method of the foregoing embodiments may be completed by instructing relevant hardware through a computer program, and the program may be stored in a computer readable storage medium. During execution, the process of the above method may be performed. The storage medium may be a magnetic disk, an optical disk, a read-only memory (ROM) or a random-access memory (RAM), etc.

The above disclosure is only part of the embodiments of the present disclosure and should not be used to limit the scope of the present disclosure. Therefore, equivalent changes made according to the present disclosure still fall within the scope of the present disclosure.

What is claimed is:

1. An image processing method comprising:
in response to detecting that a communication connection for image transmission is established between a photographing device and a terminal device, obtaining image processing information of the terminal device;
obtaining link information of the communication connection;
determining an image processing strategy based on the image processing information and the link information;
controlling the photographing device to shoot an image according to the image processing strategy; and
controlling an image transmission circuit of the photographing device to transmit the image to the terminal device according to the image processing strategy.

2. The method of claim 1, wherein:
the image processing information includes display information and codec information, the display information including at least one of a resolution or a frame rate of a display screen of the terminal device; and
determining the image processing strategy based on the image processing information and the link information includes determining the image processing strategy according to the display information and the codec information, the image processing strategy includes a shooting parameter that matches the display information and the codec information.

3. The method of claim 2, wherein controlling the photographing device to shoot the image according to the image processing strategy includes controlling the photographing device to shoot the image according to the shooting parameter such that the image captured by an image sensor of the photographing device matches the display information.

4. The method of claim 1, wherein controlling the image transmission circuit of the photographing device to transmit the image to the terminal device according to the image processing strategy includes:
controlling the photographing device to encode the image with a target bitstream according to the image processing strategy to obtain encoded data;
controlling the image transmission circuit of the photographing device to transmit the encoded data to the terminal device according to the image processing strategy.

5. The method of claim 4, wherein:
the image processing information includes codec information;
the image processing strategy indicates an encoding parameter associated with the codec information; and
controlling the photographing device to encode the image with the target bitstream includes controlling an encoding circuit of the photographing device according to the encoding parameter such that the encoding circuit encodes the image with the target bitstream.

6. The method of claim 4, wherein:
the image processing information includes transmission protocol information of the terminal device;
the image processing strategy indicates a transmission protocol parameter associated with the transmission protocol information; and
controlling the image transmission circuit of the photographing device to transmit the encoded data includes controlling the image transmission circuit according to transmission protocol parameter such that the image transmission circuit transmits the encoded data with the transmission protocol parameter.

7. The method of claim 1, further comprising:
in response to obtaining a start instruction of the photographing device, detecting whether the communication connection for image transmission is established between the photographing device and the terminal device.

8. The method of claim 1, wherein obtaining the image processing information of the terminal device includes:
in response to detecting that the communication connection for image transmission is established between the photographing device and the terminal device, obtaining a connection mode for establishing the communication connection; and
obtaining the image processing information of the terminal device according to the connection mode.

9. The method of claim 8, wherein:
the connection mode includes a wired communication connection mode; and
obtaining the image processing information of the terminal device according to the connection mode includes:
obtaining a communication protocol corresponding to the wired communication connection mode; and
obtaining the image processing information of the terminal device according to the communication protocol.

10. The method of claim 8, wherein:
the connection mode includes a wireless communication connection mode; and
obtaining the image processing information of the terminal device according to the connection mode includes:
testing a communication link corresponding to the wireless communication connection mode to obtain bandwidth information; and
obtaining the image processing information of the terminal device according to the bandwidth information.

11. The method of claim 1, wherein obtaining the image processing information of the terminal device includes:
detecting whether the photographing device enables a dynamic adjustment function of image processing; and
in response to detecting that the photographing device enables the dynamic adjustment function, sending an image processing information extraction request to the terminal device to obtain the image processing information of the terminal device.

12. The method of claim 11, wherein obtaining the image processing information of the terminal device further includes:
in response to detecting that the photographing device does not enable the dynamic adjustment function, determining preset information as the image processing information of the terminal device.

13. The method of claim 11, wherein obtaining the image processing information of the terminal device further includes:
in response to detecting that the photographing device does not enable the dynamic adjustment function, receiving a user operation generated on a configuration interface; and
obtaining image processing information configured by the user operation on the configuration interface as the image processing information of the terminal device.

14. The method of claim 11, wherein obtaining the image processing information of the terminal device further includes:
in response to detecting that the photographing device does not enable the dynamic adjustment function, receiving a user operation generated on a configuration interface; and
obtaining default image processing information selected by the user operation as the image processing information of the terminal device.

15. An image processing device comprising:
a memory storing program instructions; and
a processor configured to execute the program instructions to:
in response to detecting that a communication connection for image transmission is established between a photographing device and a terminal device, obtain image processing information of the terminal device;
obtain link information of the communication connection;
determine an image processing strategy based on the image processing information and the link information;
control the photographing device to shoot an image according to the image processing strategy; and
control an image transmission circuit of the photographing device to transmit the image to the terminal device according to the image processing strategy.

16. The device of claim 15, wherein the processor is further configured to execute the program instructions to determine the image processing strategy according to obtained display information and codec information of the terminal device, the display information including at least one of a resolution or a frame rate of a display screen of the terminal device, and the image processing strategy including a shooting parameter that matches the display information and the codec information.

17. The device of claim 16, wherein the processor is further configured to execute the program instructions to:
control the photographing device to shoot the image according to the shooting parameter such that the image captured by an image sensor of the photographing device matches the display information.

18. The device of claim 15, wherein the processor is further configured to execute the program instructions to:
in response to obtaining a start instruction of the photographing device, detect whether the communication connection for image transmission is established between the photographing device and the terminal device.

19. The device of claim 15, wherein the processor is further configured to execute the program instructions to:
in response to detecting that the communication connection for image transmission is established between the photographing device and the terminal device, detect whether the photographing device enables a dynamic adjustment function of image processing; and
in response to detecting that the photographing device enables the dynamic adjustment function, send an image processing information extraction request to the terminal device to obtain the image processing information of the terminal device.

20. An image processing system comprising:
an image processing device; and
a terminal device;
wherein:
the image processing device is configured to:
in response to detecting that a communication connection for image transmission is established between a photographing device and the terminal device, obtain image processing information of the terminal device;
obtain link information of the communication connection;
determine an image processing strategy based on the image processing information and the link information;
control the photographing device to shoot an image according to the image processing strategy; and
control an image transmission circuit of the photographing device to transmit the image to the terminal device according to the image processing strategy; and
the terminal device is configured to:
receive the image transmitted by the image processing device; and
display the received image on a display screen of the terminal device.
